(19) United States
(12) Patent Application Publication
(10) Pub. No.: US 2026/0023707 A1
(43) Pub. Date: Jan. 22, 2026

(54) USB REPEATER DEVICE AND OPERATION METHOD THEREOF

(71) Applicant: GENESYS LOGIC, INC., New Taipei City (TW)

(72) Inventor: Nai-Jen Chang, New Taipei City (TW)

(73) Assignee: GENESYS LOGIC, INC., New Taipei City (TW)

(21) Appl. No.: 19/187,976

(22) Filed: Apr. 23, 2025

Related U.S. Application Data
(60) Provisional application No. 63/673,173, filed on Jul. 19, 2024.

(30) Foreign Application Priority Data
Feb. 19, 2025 (TW) 114106020

(51) Int. Cl. G06F 13/40; G06F 1/3296

(52) U.S. Cl. CPC G06F 13/4045; G06F 1/3296; G06F 13/4068; G06F 2213/0042

(57) ABSTRACT

The USB repeater device includes a USB-host-side port, a USB-device-side port, a first repeater, a second repeater, and a control circuit. The USB-host-side port is coupled to an input terminal of the first repeater and an output terminal of the second repeater. The USB-device-side port is coupled to an output terminal of the first repeater and an input terminal of the second repeater. The control circuit detects the signal of the USB-host-side port and the signal of the USB-device-side port to dynamically determine an operation mode. When the operation mode is a waiting transaction-start mode, the first repeater operates in a standby state, and the second repeater operates in a power-off state. When the operation mode is a waiting transaction-finish mode, the first repeater and the second repeater transmit transactions between the USB-host-side port and the USB-device-side port.

### CROSS-REFERENCE TO RELATED APPLICATION

This application claims the priority benefit of U.S. provisional application Ser. No. 63/673,173, filed on Jul. 19, 2024 and Taiwan application Ser. No. 114106020, filed on Feb. 19, 2025. The entirety of each of the above-mentioned patent applications is hereby incorporated by reference herein and made a part of this specification.

### BACKGROUND

### Technical Field

The disclosure relates to a signal transmission system, and in particular relates to a universal serial bus (USB) repeater device and an operating method thereof.

### Description of Related Art

When high-speed signals pass through transmission paths such as cables or printed circuit boards, signal attenuation is severe. Generally speaking, the longer the signal transmission distance, the more severe the signal attenuation (i.e., the worse the signal quality), consequently resulting in difficulties for the receiving party at a remote location to recover the transmitted signal. Repeaters are used in USB hosts, USB cables, or USB devices to improve the signal quality of the transmission path.

The universal serial bus (USB) specification specifies the L0, L1, L2, and L3 states of link power management (LPM). The L1 state is the sleep state. The L2 state is the suspend state. The L3 state is the power-off state. A repeater entering the L1, L2, or L3 state may save power. The L0 state is the normal active state. In the L0 state, repeaters may be enabled to propagate transaction signals in real time. However, how to reduce the power consumption of the repeater entering the LO state is one of many technical issues in the USB field.

### SUMMARY

A universal serial bus (USB) repeater device and an operation method thereof are provided in the disclosure, so as to reduce power consumption in a normal active state (e.g., the L0 state specified by the USB specification).

In one embodiment of the disclosure, the USB repeater device includes a USB-host-side port, a USB-device-side port, a first repeater, a second repeater, and a control circuit. An input terminal of the first repeater is coupled to the USB-host-side port. An output terminal of the first repeater is coupled to the USB-device-side port. An input terminal of the second repeater is coupled to the USB-device-side port. An output terminal of the second repeater is coupled to the USB-host-side port. The control circuit detects a signal of the USB-host-side port and a signal of the USB-device-side port to dynamically determine an operation mode. In response to the operation mode being a waiting transaction-start mode, the control circuit controls the first repeater to operate in a standby state, and the control circuit controls the second repeater to operate in a power-off state to save power. In response to the operation mode being a waiting transaction-finish mode, the control circuit controls the first repeater and the second repeater to transmit at least one transaction between the USB-host-side port and the USB-device-side port.

In one embodiment of the disclosure, the above-mentioned operation method includes the following operation. A signal of a USB-host-side port of a USB repeater device and a signal of a USB-device-side port of the USB repeater device are detected by a control circuit of the USB repeater device to dynamically determine an operation mode. In response to the operation mode being a waiting transaction-start mode, a first repeater of the USB repeater device is controlled by the control circuit to operate in a standby state, and a second repeater of the USB repeater device is controlled by the control circuit to operate in a power-off state to save power. The USB-host-side port is coupled to an input terminal of the first repeater and an output terminal of the second repeater, and the USB-device-side port is coupled to an output terminal of the first repeater and an input terminal of the second repeater. In response to the operation mode being a waiting transaction-finish mode, the first repeater and the second repeater are controlled by the control circuit to transmit at least one transaction between the USB-host-side port and the USB-device-side port.

Based on the above, the USB repeater device described in the embodiments of the disclosure may detect signals from the USB-host-side port and the USB-device-side port in real time in a normal active state (e.g., the LO state specified by the USB specification) to dynamically determine the operation mode. When both the USB-host-side port and the USB-device-side port are idle for a long time, the USB repeater device enters the waiting transaction-start mode. Each transaction starts with the USB host sending the first packet unidirectionally to the USB device, and then the USB host and the USB device perform bidirectional transaction transmission. When the operation mode is the waiting transaction-start mode, the USB repeater device detects the signal of the USB-host-side port in real time to wait for the start of the next transaction. During the waiting period for the “start of transaction”, it may be confirmed that the USB device does not send a signal to the USB host, so the second repeater operates in a power-off state to save power. Therefore, the USB repeater device may reduce power consumption in a normal active state.

In order to make the above-mentioned features and advantages of the disclosure comprehensible, embodiments accompanied with drawings are described in detail below.

### BRIEF DESCRIPTION OF THE DRAWINGS

FIG. 1 is a block diagram of a signal transmission system of the disclosure.

FIG. 2 is a circuit block diagram of a USB repeater device of an embodiment of the disclosure.

FIG. 3 is an operation flowchart of a USB repeater device of an embodiment of the disclosure.

FIG. 4 is a schematic diagram of the operation mode of a USB repeater device of an embodiment of the disclosure.

FIG. 5 is a schematic diagram of the operation mode of a USB repeater device of another embodiment of the disclosure.

FIG. 6 is a circuit block schematic diagram of a repeater and a control circuit of an embodiment of the disclosure.

### DETAILED DESCRIPTION OF DISCLOSED EMBODIMENTS

The term “coupled (or connected)” as used throughout this specification (including the scope of the application) may refer to any direct or indirect means of connection. For example, if it is described in the specification that a first device is coupled (or connected) to a second device, it should be construed that the first device may be directly connected to the second device, or the first device may be indirectly connected to the second device through another device or some type of connecting means. Terms “first,” “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of the elements. In addition, wherever possible, elements/components/steps with the same reference numerals in the drawings and embodiments represent the same or similar parts. Elements/components/steps that use the same reference numerals or use the same terminology in different embodiments may refer to relevant descriptions of each other.

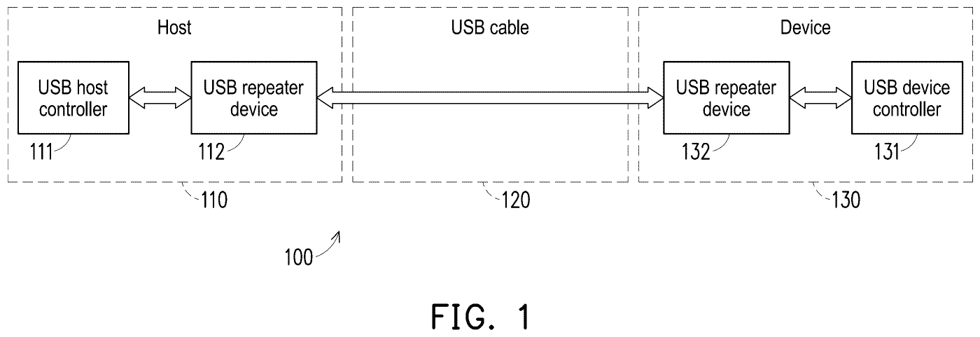

FIG. 1 is a block diagram of a signal transmission system of the disclosure. The signal transmission system 100 of FIG. 1 includes a host 110, a universal serial bus (USB) cable 120, and a device 130. The USB cable 120 is connected between the host 110 and the device 130, so that the host 110 and the device 130 may communicate with each other through the USB cable 120. In this embodiment, a USB repeater device is used in a transmission path between a USB host controller 111 of a host 110 and a USB device controller 131 of a device 130 to perform a repeating function in a signal transmission system 100. The USB repeater device may regenerate the signal to improve the signal quality of the signal transmission system 100. The location and number of USB repeater devices may be determined according to actual design and application. The USB repeater device in this embodiment may be a retimer device or a redriver device. For example, the USB repeater device 112 may be disposed between the USB host controller 111 and the USB cable 120, and/or the USB repeater device 132 may be disposed between the USB device controller 131 and the USB cable 120 to improve signal quality.

For example, a USB-host-side port of the USB repeater device 112 is coupled to the USB host controller 111. In one application example, the USB-host-side port of the USB repeater device 112 includes a data channel, such as a differential pair Dp and Dn (or recorded as D+ and D−) compliant with the USB 2 specification, or a differential pair eDp and eDn (or recorded as eD+ and eD−) compliant with the embedded USB2 (eUSB2) specification. A USB-device-side port of the USB repeater device 112 is coupled to the USB cable 120. The USB-device-side port of the USB repeater device 112 includes a data channel, such as a differential pair Dp and Dn compliant with the USB 2 specification.

The USB-host-side port of the USB repeater device 132 is coupled to the USB cable 120. The USB-host-side port of the USB repeater device 132 includes a data channel, such as a differential pair Dp and Dn compliant with the USB2 specification. The USB-device-side port of the USB repeater device 132 is coupled to the USB device controller 131. In one application example, the USB-device-side port of the USB repeater device 132 includes a data channel, such as a differential pair Dp and Dn compliant with the USB 2 specification, or a differential pair eDp and eDn compliant with the eUSB 2 specification.

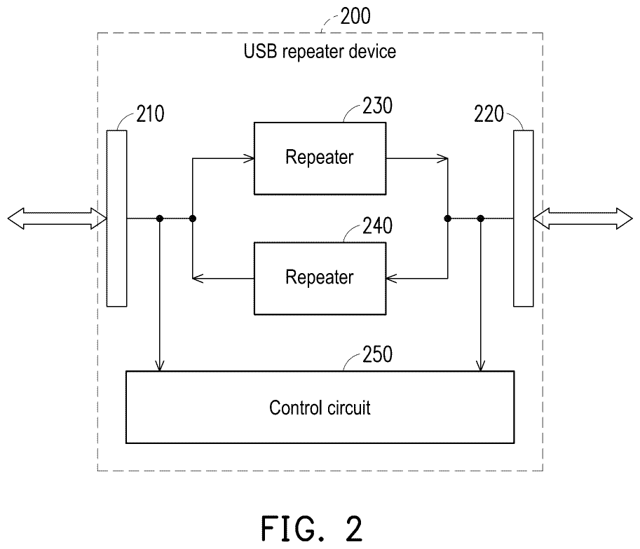

FIG. 2 is a circuit block diagram of a USB repeater device of an embodiment of the disclosure. The USB repeater device 200 shown in FIG. 2 may serve as one of many implementation examples of any one of the USB repeater devices 112 and 132 shown in FIG. 1. For the USB repeater device 200 shown in FIG. 2, reference may be made to the relevant description of the USB repeater device 112 or 132 shown in FIG. 1. In the embodiment shown in FIG. 2, the USB repeater device 200 includes a USB-host-side port 210, a USB-device-side port 220, a repeater 230, a repeater 240, and a control circuit 250. The control circuit 250 detects the signal of the data channel of the USB-host-side port 210 and the signal of the data channel of the USB-device-side port 220 to dynamically determine the operation mode of the USB repeater device 200. According to different designs, the control circuit 250 may be implemented as a hardware circuit or a combination of hardware, firmware, and software (i.e., program).

In terms of hardware, the control circuit 250 may be implemented as a logic circuit on an integrated circuit. For example, the above-mentioned related functions of the control circuit 250 may be implemented in one or more hardware controllers, microcontrollers, hardware processors, microprocessors, application-specific integrated circuits (ASICs), digital signal processors (DSPs), field programmable gate arrays (FPGAs), central processing units (CPUs) and/or various logic blocks, modules, and circuits in other processing units. The related functions of the control circuit 250 may be implemented as hardware circuits by using hardware description languages (e.g., Verilog HDL or VHDL), or other suitable programming languages, such as various logic blocks, modules, and circuits in integrated circuits.

In terms of software and/or firmware, the related functions of the above-mentioned control circuit 250 may be implemented as programming codes. For example, the control circuit 250 may be implemented using general programming languages (e.g., C, C++, or assembly language) or other suitable programming languages. The programming code may be recorded/stored in a “non-transitory machine-readable storage medium”. In some embodiments, the non-transitory machine-readable storage medium includes, for example, a semiconductor memory and/or a storage device. An electronic device (e.g., a CPU, a hardware controller, a microcontroller, a hardware processor, or a microprocessor) may read and execute the programming code from the non-transitory machine-readable storage medium, thereby achieving related functions of the control circuit 250.

In one embodiment, the data channel of the USB-host-side port 210 includes a differential pair eDp and eDn compliant with the eUSB 2 specification, and the data channel of the USB-device-side port 220 includes a differential pair Dp and Dn compliant with the USB 2 specification. In another embodiment, the data channel of the USB-device-side port 220 includes a differential pair eDp and eDn compliant with the eUSB 2 specification, and the data channel of the USB-host-side port 210 includes a differential pair Dp and Dn compliant with the USB 2 specification. In yet another embodiment, the data channel of each of the USB-host-side port 210 and the USB-device-side port 220 includes a differential pair Dp and Dn compliant with the USB2 specification. An input terminal of the repeater 230 is coupled to a data channel (e.g., a differential pair eDp and eDn, or a differential pair Dp and Dn) of the USB-host-side port 210. An output terminal of the repeater 230 is coupled to the data channel (e.g., the differential pair eDp and eDn, or the differential pair Dp and Dn) of the USB-device-side port 220. An input terminal of the repeater 240 is coupled to the data channel of the USB-device-side port 220. An output terminal of the repeater 240 is coupled to a data channel of the USB-host-side port 210.

The control circuit 250 detects the signal of the USB-host-side port 210 and the signal of the USB-device-side port 220 to dynamically determine the operation mode. In response to the operation mode entering the high-speed (HS) mode compliant with the USB specification, the control circuit 250 controls the USB repeater device 200 to enter a waiting transaction-start mode.

In the HS mode, the USB repeater device 200 is enabled to serve as a data transmission channel between the USB-host-side port 210 and the USB-device-side port 220. Specifically, in this embodiment, when the operation mode enters the high-speed mode compliant with the USB specification, the control circuit 250 controls the USB repeater device 200 to enter the waiting transaction-start mode. Furthermore, the control circuit 250, for example, controls the repeater 230 to operate in a standby state, and the control circuit 250 controls the repeater 240 to operate in a power-off state to save power. The operation mode, for example, transitions from the low-speed (LS) mode or full-speed (FS) mode compliant with the USB specification to the high-speed mode compliant with the USB specification.

In one embodiment, in response to the operation mode being in the low-speed mode or the full-speed mode compliant with the USB specification, the control circuit 250 controls the repeaters 230 and 240 to operate in a power-off state. In the LS or FS mode, for example, a redriver (not shown) for the LS mode and the FS mode may be provided, and the redriver may be enabled to serve as a data transmission channel between the USB-host-side port 210 and the USB-device-side port 220. This embodiment does not limit the specific implementation of the “redriver for the LS and FS modes”. In the HS mode, the “redriver for the LS and FS modes” (not shown) is disabled to save power consumption. In addition, this embodiment does not limit whether the “redriver for the LS and FS modes” is provided or not.

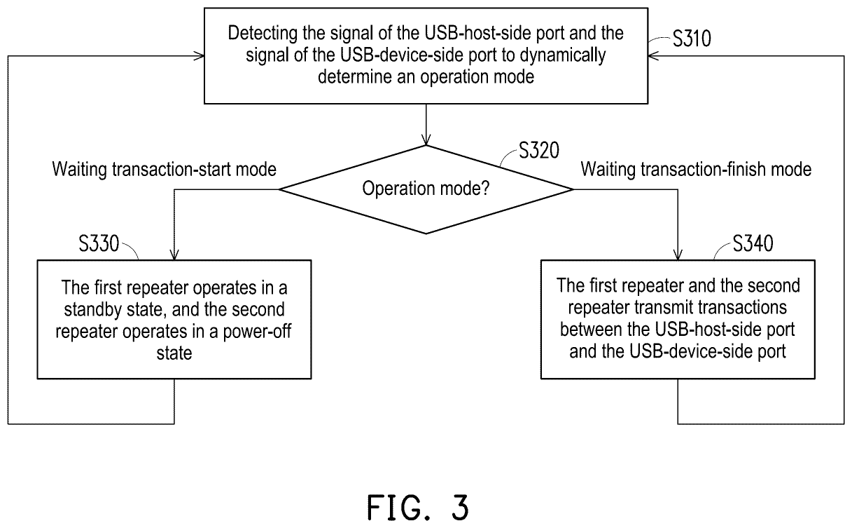

FIG. 3 is an operation flowchart of a USB repeater device of an embodiment of the disclosure. The process shown in FIG. 3 is operated in the LO state (normal active state) of the link power management (LPM) specified in the USB specification. Referring to FIG. 2 and FIG. 3, in step S310, the control circuit 250 detects the signal of the USB-host-side port 210 and the signal of the USB-device-side port 220 to dynamically determine the operation mode. The operation modes include at least a waiting transaction-start mode and a waiting transaction-finish mode. The so-called “waiting transaction-start mode” means that the USB repeater device 200 detects the signal of the USB-host-side port 210 in real time to wait for the start of a transaction. The so-called “transaction” has been specified in the USB protocol, so details are not repeated herein. The so-called “waiting transaction-finish mode” means that the USB repeater device 200 detects the signal of the USB-host-side port 210 in real time to wait for the end of the current transaction.

In response to the operation mode being the waiting transaction-start mode (the determination result of step S320 is “waiting transaction-start mode”), the control circuit 250 controls the repeater 230 to operate in a standby state, and the control circuit 250 controls the repeater 240 to operate in a power-off state to save power (step S330). The output terminal of the repeater 230 in the standby state is in a high impedance (i.e., open circuit, or referred to as Hi-Z) state. The standby state is a power saving state in which the repeater 230 may be awakened within a time specified by the USB2 specification or the eUSB2 specification. The so-called “awakened” means that the repeater 230 enters an active state from a standby state. In response to a signal toggling (indicating the start of a new transaction transmission) occurring at the USB-host-side port 210, the control circuit 250 changes the operation mode from the waiting transaction-start mode to the waiting transaction-finish mode.

In response to the operation mode being the waiting transaction-finish mode (the determination result of step S320 is “waiting transaction-finish mode”), the control circuit 250 controls the repeaters 230 and 240 to transmit at least one transaction between the USB-host-side port 210 and the USB-device-side port 220 (step S340). Therefore, the USB repeater device 200 may operate normally. In response to the completion of the current transaction (both the USB-host-side port 210 and the USB-device-side port 220 are idle for a certain threshold time, and this threshold time is set based on the USB specification for transaction transmission), the control circuit 250 changes the operation mode from the waiting transaction-finish mode to the waiting transaction-start mode.

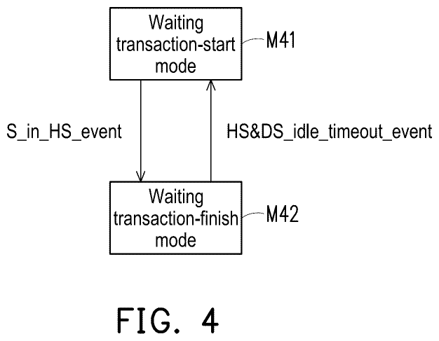

FIG. 4 is a schematic diagram of the operation mode of a USB repeater device of an embodiment of the disclosure. Referring to FIG. 2 and FIG. 4, the control circuit 250 detects the signal of the USB-host-side port 210 to obtain a host-side channel detection result. The control circuit 250 may also detect the signal of the USB-device-side port 220 to obtain a device-side channel detection result. When both the USB-host-side port 210 and the USB-device-side port 220 are idle for a long time, the USB repeater device 200 remains in the waiting transaction-start mode M41. In response to the host-side channel detection result indicating that a signal toggling event S_in_HS_event occurs at the USB-host-side port 210, i.e., a voltage level toggling occurs at the data channel of the USB-host-side port 210, the control circuit 250 changes the operation mode from the waiting transaction-start mode M 41 to the waiting transaction-finish mode M 42. In a preferred embodiment, any signal or packet detected at the USB-host-side port 210 is defined as a signal toggling event. Furthermore, as long as the USB-host-side port 210 detects any signal or packet, the control circuit 250 changes the operation mode from the waiting transaction-start mode M 41 to the waiting transaction-finish mode M 42 without any need to determine the data or packet content. In response to the host-side channel detection result and the device-side channel detection result indicate that a long idle event HS& DS_idle_timeout_event occurs at the USB-host-side port 210 and the USB-device-side port 220, i.e., both the USB-host-side port 210 and the USB-device-side port 220 are idle for a certain threshold time (this threshold time is set based on the USB specification for transaction transmission), the control circuit 250 changes the operation mode from the waiting transaction-finish mode M 42 to the waiting transaction-start mode M 41.

The control circuit 250 controls the repeaters 230 and 240 in the waiting transaction-finish mode to transmit transactions between the USB-host-side port 210 and the USB-device-side port 220, so that the USB repeater device 200 may work normally. For example, in response to the host-side channel detection result indicating that a voltage level toggling occurs at the data channel of the USB-host-side port 210, the control circuit 250 controls the repeater 230 to operate in an active state to transmit the packet of the USB-host-side port 210 to the USB-device-side port 220, and the control circuit 250 controls the repeater 240 to operate in a standby state. In response to the host-side channel detection result indicating that the USB-host-side port 210 is idle, the control circuit 250 controls the repeater 230 to return from the active state to the standby state, and the control circuit 250 controls the repeater 240 to remain in the standby state. In response to the device-side channel detection result indicating that a voltage level toggling occurs at the data channel of the USB-device-side port 220, the control circuit 250 controls the repeater 240 to operate in an active state to transmit the packet of the USB-device-side port 220 to the USB-host-side port 210, and the control circuit 250 controls the repeater 230 to operate in a standby state. In response to the device-side channel detection result indicating that the USB-device-side port 220 is idle, the control circuit 250 controls the repeater 240 to return from the active state to the standby state, and the control circuit 250 controls the repeater 230 to remain in the standby state.

In summary, the USB repeater device 200 may detect signals from the USB-host-side port 210 and the USB-device-side port 220 in real time in a normal active state (e.g., the LO state specified by the USB specification) to dynamically determine the operation mode. When both the USB-host-side port 210 and the USB-device-side port 220 are idle for a period of time or for a long time, the USB repeater device 200 enters the waiting transaction-start mode M 41. Each transaction starts with the USB host 110 sending the first packet unidirectionally to the USB device 130, and then the USB host 110 and the USB device 130 perform bidirectional transaction transmission. When the operation mode is the waiting transaction-start mode M 41, the USB repeater device 200 detects whether a voltage level toggling occurs at the data channel of the USB-host-side port 210 in real time to wait for the start of a transaction. During the waiting period for the “start of transaction”, it may be confirmed that the USB device 130 does not send a signal to the USB host 110, so the repeater 240 may operate in a power-off state to save power until the start of the next transaction. Therefore, the USB repeater device 200 may reduce power consumption in a normal active state (e.g., the LO state specified by the USB specification).

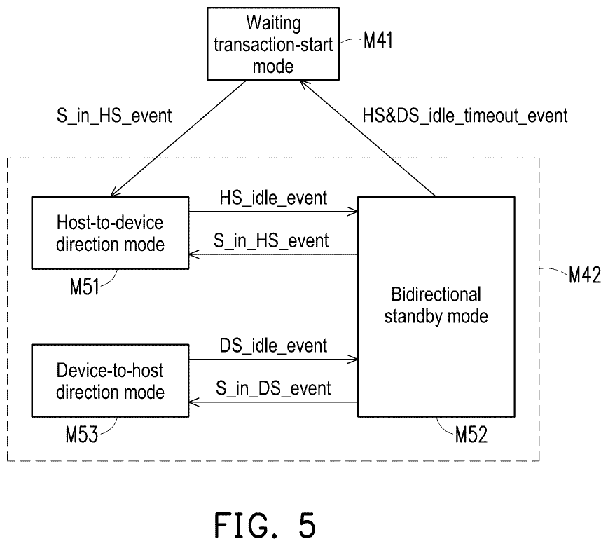

FIG. 5 is a schematic diagram of the operation mode of a USB repeater device of another embodiment of the disclosure. For the waiting transaction-start mode M 41 and waiting transaction-finish mode M 42 shown in FIG. 5, reference may be made to the related description of FIG. 4, so details are not repeated herein. In the embodiment shown in FIG. 5, the waiting transaction-finish mode M 42 includes a host-to-device direction mode M 51, a bidirectional standby mode M 52, and a device-to-host direction mode M 53. Referring to FIG. 2 and FIG. 5, the control circuit 250 detects the signal of the USB-host-side port 210 to obtain a host-side channel detection result. The control circuit 250 may also detect the signal of the USB-device-side port 220 to obtain a device-side channel detection result. In response to the host-side channel detection result indicating that a signal toggling event S_in_HS_event occurs at the USB-host-side port 210, i.e., a voltage level toggling occurs at the data channel of the USB-host-side port 210, the control circuit 250 changes the operation mode from the waiting transaction-start mode M 41 to the host-to-device direction mode M 51.

In the host-to-device direction mode M 51, the repeater 230 operates in an active state to transmit packets of the USB-host-side port 210 to the USB-device-side port 220, and the repeater 240 operates in a standby state. In response to the host-side channel detection result indicating that an idle event HS_idle_event occurs at the USB-host-side port 210, i.e., the USB-host-side port 210 is idle (the USB-device-side port 220 is also idle at this time), the control circuit 250 changes the operation mode from the host-to-device direction mode M 51 to the bidirectional standby mode M 52.

In the bidirectional standby mode M 52, the repeater 230 and the repeater 240 both remain in the standby state. In response to the host-side channel detection result indicating that a signal toggling event S_in_HS_event occurs at the USB-host-side port 210, i.e., a voltage level toggling occurs at the data channel of the USB-host-side port 210, the control circuit 250 changes the operation mode from the bidirectional standby mode M 52 to the host-to-device direction mode M 51. In response to the device-side channel detection result indicating that a voltage toggling event S_in_DS_event occurs at the data channel of the USB-device-side port 220, i.e., a voltage level toggling occurs at the data channel of the USB-device-side port 220, the control circuit 250 changes the operation mode from the bidirectional standby mode M 52 to the device-to-host direction mode M 53.

In the device-to-host direction mode M 53, the repeater 240 operates in an active state to transmit packets from the USB-device-side port 220 to the USB-host-side port 210, and the repeater 230 operates in a standby state. In response to the device-side channel detection result indicating that an idle event DS_idle_event occurs at the USB-device-side port 220, i.e., the USB-device-side port 220 is idle (the USB-host-side port 210 is also idle at this time), the control circuit 250 changes the operation mode from the device-to-host direction mode M 53 to the bidirectional standby mode M 52. In response to the host-side channel detection result and the device-side channel detection result indicate that a long idle event HS& DS_idle_timeout_event occurs at the USB-host-side port 210 and the USB-device-side port 220, i.e., both the USB-host-side port 210 and the USB-device-side port 220 are idle for a certain threshold time (this threshold time is set based on the USB specification for transaction transmission), the control circuit 250 changes the operation mode from the bidirectional standby mode M 52 to the waiting transaction-start mode M 41.

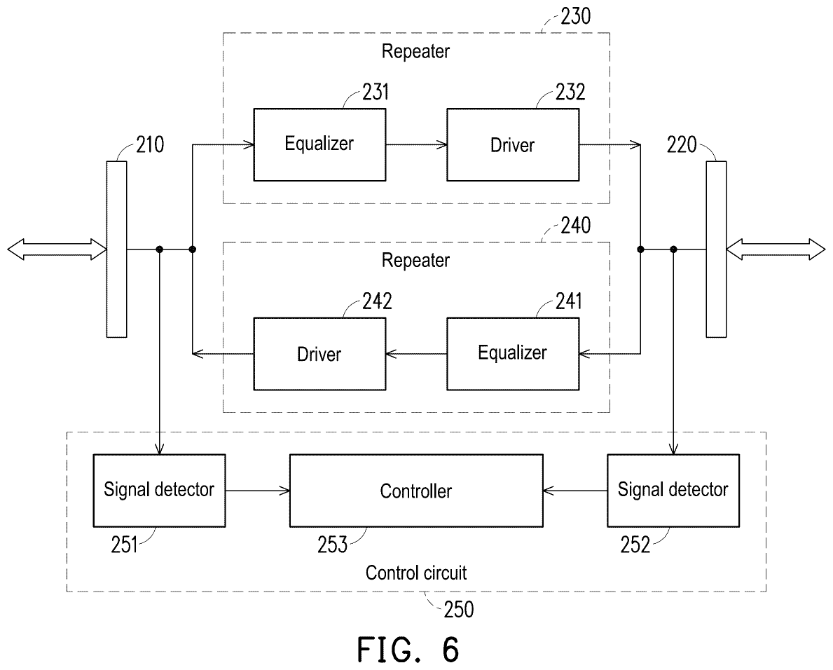

FIG. 6 is a circuit block schematic diagram of a repeater 230, a repeater 240, and a control circuit 250 of an embodiment of the disclosure. The repeater 230, the repeater 240, and the control circuit 250 shown in FIG. 6 may be one of many implementation examples of the repeater 230, the repeater 240, and the control circuit 250 shown in FIG. 2. For the USB-host-side port 210, the USB-device-side port 220, the repeater 230, the repeater 240 and the control circuit 250 shown in FIG. 6, reference may be made to the related description of FIG. 2, so details are not repeated herein.

In the embodiment shown in FIG. 6, the control circuit 250 includes a signal detector 251, a signal detector 252, and a controller 253. The signal detector 251 is configured to detect the voltage level toggling of the data channel of the USB-host-side port 210. The controller 253 is coupled to the signal detector 251 to receive the host-side channel detection result. The signal detector 252 is configured to detect the voltage level toggling of the data channel of the USB-device-side port 220. The controller 253 is coupled to the signal detector 252 to receive the device-side channel detection result. The relevant functions of the controller 253 may be implemented in various logic blocks, modules and circuits in a hardware controller, a microcontroller, a hardware processor, a microprocessor, an ASIC, a DSP, an FPGA, a CPU and/or other processing units. The related functions of the controller 253 may be implemented as hardware circuits by using hardware description languages (e.g., Verilog HDL or VHDL), or other suitable programming languages, such as various logic blocks, modules, and circuits in integrated circuits.

In response to the host-side channel detection result of the signal detector 251 indicating that a voltage level toggling occurs at the data channel of the USB-host-side port 210, the controller 253 changes the operation mode from the waiting transaction-start mode M 41 to the waiting transaction-finish mode M 42. In response to the host-side channel detection result of the signal detector 251 and the device-side channel detection result of the signal detector 252 indicating that both the USB-host-side port 210 and the USB-device-side port 220 are idle for a certain threshold time (this threshold time is set based on the USB specification for transaction transmission), the controller 253 changes the operation mode from the waiting transaction-finish mode M 42 to the waiting transaction-start mode M 41.

Referring to FIG. 5 and FIG. 6, in response to a signal toggling event S_in_HS_event occurring in the USB-host-side port 210, i.e., a voltage level toggling occurs at the data channel of the USB-host-side port 210, the controller 253 changes the operation mode from the waiting transaction-start mode M 41 to the host-to-device direction mode M 51. In the host-to-device direction mode M 51, the repeater 230 operates in an active state and the repeater 240 operates in a standby state. In response to an idle event HS_idle_event occurring on the USB-host-side port 210, i.e., the USB-host-side port 210 is idle (the USB-device-side port 220 is also idle at this time), the controller 253 changes the operation mode from the host-to-device direction mode M 51 to the bidirectional standby mode M 52. In the bidirectional standby mode M 52, the repeater 230 and the repeater 240 both remain in the standby state. In response to a signal toggling event S_in_HS_event occurring in the USB-host-side port 210, i.e., a voltage level toggling occurs at the data channel of the USB-host-side port 210, the controller 253 changes the operation mode from the bidirectional standby mode M 52 to the host-to-device direction mode M 51. In response to a signal toggling event S_in_DS_event occurring in the USB-device-side port 220, i.e., a voltage level toggling occurs at the data channel of the USB-device-side port 220, the controller 253 changes the operation mode from the bidirectional standby mode M 52 to the device-to-host direction mode M 53. In the device-to-host direction mode M 53, the repeater 240 operates in an active state and the repeater 230 operates in a standby state. In response to an idle event DS_idle_event occurring at the USB-device-side port 220, i.e., the USB-device-side port 220 is idle (the USB-host-side port 210 is also idle at this time), the controller 253 changes the operation mode from the device-to-host direction mode M 53 to the bidirectional standby mode M 52. In response to a long idle event HS& DS_idle_timeout_event occurring in the USB-host-side port 210 and the USB-device-side port 220, i.e., both the USB-host-side port 210 and the USB-device-side port 220 are idle for a certain threshold time (this threshold time is set based on the USB specification for transaction transmission), the controller 253 changes the operation mode from the bidirectional standby mode M 52 to the waiting transaction-start mode M 41.

In the embodiment shown in FIG. 6, the repeater 230 includes an equalizer 231 and a driver 232. An input terminal of the equalizer 231 is coupled to an input terminal of the repeater 230, ie, coupled to the data channel of the USB-host-side port 210. An input terminal of the driver 232 is coupled to an output terminal of the equalizer 231. An output terminal of the driver 232 is coupled to an output terminal of the repeater 230, i.e., coupled to the data channel of the USB-device-side port 220. In response to the repeater 230 operating in the active state, the controller 253 controls the equalizer 231 and the driver 232 to operate in a normal power-on state to transmit the packets of the USB-host-side port 210 to the USB-device-side port 220. In response to the repeater 230 operating in the standby state, the controller 253 controls the output terminal of the driver 232 to be in a high impedance (or referred to as Hi-Z) state (at this time, the equalizer 231 may remain in the active state). The driver 232 may return to the active state from the standby state in real time within the time (e.g., 8 ns) specified by the USB 2 specification or the eUSB 2 specification.

In the embodiment shown in FIG. 6, the repeater 240 includes an equalizer 241 and a driver 242. An input terminal of the equalizer 241 is coupled to an input terminal of the repeater 240, i.e., coupled to the data channel of the USB-device-side port 220. An input terminal of the driver 242 is coupled to an output terminal of the equalizer 241. An output terminal of the driver 242 is coupled to an output terminal of the repeater 240, i.e., coupled to the data channel of the USB-host-side port 210. In response to the repeater 240 operating in the active state, the controller 253 controls the equalizer 241 and the driver 242 to operate in a normal power-on state to transmit the packets of the USB-device-side port 220 to the USB-host-side port 210. In response to the repeater 240 operating in the standby state, the controller 253 controls the output terminal of the driver 242 to be in a high impedance (or referred to as Hi-Z) state (at this time, the equalizer 241 may remain in the active state). The driver 242 may return to the active state from the standby state in real time within the time (e.g., 8 ns) specified by the USB 2 specification or the eUSB 2 specification. In some application examples, in response to the operation mode being the waiting transaction-start mode M 41, the controller 253 controls the equalizer 241 to operate in a normal power-on state, and the controller 253 controls the driver 242 to operate in a power-off state. In some other application examples, in response to the operation mode being the waiting transaction-start mode M 41, the controller 253 controls the equalizer 241 and the driver 242 to operate in a power-off state.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A USB repeater device comprising:
a USB-host-side port;
a USB-device-side port;
a first repeater having an input terminal coupled to the USB-host-side port, wherein an output terminal of the first repeater is coupled to the USB-device-side port;
a second repeater having an input terminal coupled to the USB-device-side port, wherein an output terminal of the second repeater is coupled to the USB-host-side port; and
a control circuit coupled to the USB-host-side port and the USB-device-side port to detect a signal of the USB-host-side port and a signal of the USB-device-side port to dynamically determine an operation mode, wherein,
in response to the operation mode being a waiting transaction-start mode, the control circuit controls the first repeater to operate in a standby state, and the control circuit controls the second repeater to operate in a power-off state to save power; and
in response to the operation mode being a waiting transaction-finish mode, the control circuit controls the first repeater and the second repeater to transmit at least one transaction between the USB-host-side port and the USB-device-side port.

2. The USB repeater device according to claim 1, wherein a data channel of one of the USB-host-side port and the USB-device-side port comprises a differential pair eDp and eDn compliant with an embedded USB 2 specification, and a data channel of another one of the USB-host-side port and the USB-device-side port comprises a differential pair Dp and Dn compliant with a USB 2 specification.

3. The USB repeater device according to claim 1, wherein a data channel of each of the USB-host-side port and the USB-device-side port comprises a differential pair Dp and Dn compliant with a USB 2 specification.

4. The USB repeater device according to claim 1, wherein the standby state is a power saving state in which the first repeater may be awakened within a time specified by a USB 2 specification or an embedded USB 2 specification, and the output terminal of the first repeater in the standby state is in a high impedance state.

5. The USB repeater device according to claim 1, wherein the control circuit detects the signal of the USB-host-side port to obtain a host-side channel detection result, and the control circuit detects the signal of the USB-device-side port to obtain a device-side channel detection result,
in response to the host-side channel detection result indicating that a voltage level toggling occurs at a data channel of the USB-host-side port, the control circuit changes the operation mode from the waiting transaction-start mode to the waiting transaction-finish mode; and
in response to the host-side channel detection result and the device-side channel detection result indicating that both the USB-host-side port and the USB-device-side port are idle for a threshold time, the control circuit changes the operation mode from the waiting transaction-finish mode to the waiting transaction-start mode.

6. The USB repeater device according to claim 5, wherein,
the voltage level toggling occurring at the USB-host-side port indicates that a signal toggling event occurs at the USB-host-side port; and
the USB-host-side port and the USB-device-side port both idling for the threshold time indicates that a long idle event occurs at the USB-host-side port and the USB-device-side port.

7. The USB repeater device according to claim 5, wherein in the waiting transaction-finish mode:
in response to the host-side channel detection result indicating that the voltage level toggling occurs at the data channel of the USB-host-side port, the control circuit controls the first repeater to operate in an active state to transmit at least one packet of the USB-host-side port to the USB-device-side port, and the control circuit controls the second repeater to operate in the standby state;
in response to the host-side channel detection result indicating that the USB-host-side port is idle, the control circuit controls the first repeater to return from the active state to the standby state, and the control circuit controls the second repeater to remain in the standby state;
in response to the device-side channel detection result indicating that the voltage level toggling occurs at a data channel of the USB-device-side port, the control circuit controls the second repeater to operate in the active state to transmit at least one packet of the USB-device-side port to the USB-host-side port, and the control circuit controls the first repeater to operate in the standby state; and
in response to the device-side channel detection result indicating that the USB-device-side port is idle, the control circuit controls the second repeater to return from the active state to the standby state, and the control circuit controls the first repeater to remain in the standby state.

8. The USB repeater device according to claim 1, wherein the control circuit detects the signal of the USB-host-side port to obtain a host-side channel detection result, the control circuit detects the signal of the USB-device-side port to obtain a device-side channel detection result, the waiting transaction-finish mode comprises a host-to-device direction mode, a device-to-host direction mode, and a bidirectional standby mode,
in response to the host-side channel detection result indicating that a voltage level toggling occurs at a data channel of the USB-host-side port, the control circuit changes the operation mode from the waiting transaction-start mode to the host-to-device direction mode, wherein in the host-to-device direction mode, the first repeater operates in an active state to transmit at least one packet of the USB-host-side port to the USB-device-side port, and the second repeater operates in the standby state;
in response to the host-side channel detection result indicating that the USB-host-side port is idle, the control circuit changes the operation mode from the host-to-device direction mode to the bidirectional standby mode, wherein in the bidirectional standby mode, the first repeater and the second repeater both remain in the standby state;
in response to the host-side channel detection result indicating that the voltage level toggling occurs at the data channel of the USB-host-side port, the control circuit changes the operation mode from the bidirectional standby mode to the host-to-device direction mode;
in response to the device-side channel detection result indicating that the voltage level toggling occurs at a data channel of the USB-device-side port, the control circuit changes the operation mode from the bidirectional standby mode to the device-to-host direction mode, wherein in the device-to-host direction mode, the second repeater operates in the active state to transmit at least one packet of the USB-device-side port to the USB-host-side port, and the first repeater operates in the standby state;
in response to the device-side channel detection result indicating that the USB-device-side port is idle, the control circuit changes the operation mode from the device-to-host direction mode to the bidirectional standby mode; and
in response to the host-side-channel detection result and the device-side channel detection result indicating that both the USB-host-side port and the USB-device-side port are idle for a threshold time, the control circuit changes the operation mode from the bidirectional standby mode to the waiting transaction-start mode.

9. The USB repeater device according to claim 1, wherein the second repeater comprises:
an equalizer having an input terminal coupled to the input terminal of the second repeater; and
a driver having an input terminal coupled to an output terminal of the equalizer, wherein an output terminal of the driver is coupled to the output terminal of the second repeater, and
in response to the operation mode being the waiting transaction-start mode, the control circuit controls at least one of the equalizer and the driver to operate in the power-off state.

10. The USB repeater device according to claim 1, wherein the control circuit comprises:
a first signal detector coupled to the USB-host-side port to detect a voltage level toggling of a data channel of the USB-host-side port;
a second signal detector coupled to the USB-device-side port to detect the voltage level toggling of a data channel of the USB-device-side port; and
a controller, coupled to the first signal detector to receive a host-side channel detection result, and coupled to the second signal detector to receive a device-side channel detection result, wherein,
in response to the host-side channel detection result indicating that the voltage level toggling occurs at the data channel of the USB-host-side port, the controller changes the operation mode from the waiting transaction-start mode to the waiting transaction-finish mode; and
in response to the host-side channel detection result and the device-side channel detection result indicating that both the USB-host-side port and the USB-device-side port are idle for a threshold time, the controller changes the operation mode from the waiting transaction-finish mode to the waiting transaction-start mode.

11. The USB repeater device according to claim 1, wherein,
in response to the operation mode entering a low-speed mode or a full-speed mode compliant with a USB specification, the control circuit controls both the first repeater and the second repeater to operate in the power-off state; and
in response to the operation mode entering a high-speed mode compliant with the USB specification from the low-speed mode or the full-speed mode, the control circuit controls the USB repeater device to enter the waiting transaction-start mode.

12. An operating method of a USB repeater device, comprising:
detecting a signal of a USB-host-side port of the USB repeater device and a signal of a USB-device-side port of the USB repeater device by a control circuit of the USB repeater device to dynamically determine an operation mode;
in response to the operation mode being a waiting transaction-start mode, controlling a first repeater of the USB repeater device by the control circuit to operate in a standby state, and controlling a second repeater of the USB repeater device by the control circuit to operate in a power-off state to save power, wherein the USB-host-side port is coupled to an input terminal of the first repeater and an output terminal of the second repeater, and the USB-device-side port is coupled to an output terminal of the first repeater and an input terminal of the second repeater; and
in response to the operation mode being a waiting transaction-finish mode, controlling the first repeater and the second repeater by the control circuit to transmit at least one transaction between the USB-host-side port and the USB-device-side port.

13. The operating method according to claim 12, wherein a data channel of one of the USB-host-side port and the USB-device-side port comprises a differential pair eDp and eDn compliant with an embedded USB 2 specification, and a data channel of another one of the USB-host-side port and the USB-device-side port comprises a differential pair Dp and Dn compliant with a USB 2 specification.

14. The operating method according to claim 12, wherein a data channel of each of the USB-host-side port and the USB-device-side port comprises a differential pair Dp and Dn compliant with a USB 2 specification.

15. The operating method according to claim 12, wherein the standby state is a power saving state in which the first repeater may be awakened within a time specified by a USB 2 specification or an embedded USB 2 specification, and the output terminal of the first repeater in the standby state is in a high impedance state.

16. The operating method according to claim 12, further comprising:
detecting the signal of the USB-host-side port by the control circuit to obtain a host-side channel detection result;
detecting the signal of the USB-device-side port by the control circuit to obtain a device-side channel detection result;
in response to the host-side channel detection result indicating that a voltage level toggling occurs at a data channel of the USB-host-side port, changing the operation mode from the waiting transaction-start mode to the waiting transaction-finish mode by the control circuit; and
in response to the host-side channel detection result and the device-side channel detection result indicating that both the USB-host-side port and the USB-device-side port are idle for a threshold time, changing the operation mode from the waiting transaction-finish mode to the waiting transaction-start mode by the control circuit.

17. The operating method according to claim 16, further comprising:
controlling the first repeater to operate in an active state to transmit at least one packet of the USB-host-side port to the USB-device-side port, and controlling the second repeater to operate in the standby state in response to the host-side channel detection result indicating that the voltage level toggling occurs at the data channel of the USB-host-side port in the waiting transaction-finish mode;
controlling the first repeater to return from the active state to the standby state, and controlling the second repeater to remain in the standby state in response to the host-side channel detection result indicating that the USB-host-side port is idle in the waiting transaction-finish mode;
controlling the second repeater to operate in the active state to transmit at least one packet of the USB-device-side port to the USB-host-side port, and controlling the first repeater to operate in the standby state in response to the device-side channel detection result indicating that the voltage level toggling occurs at a data channel of the USB-device-side port in the waiting transaction-finish mode; and
controlling the second repeater to return from the active state to the standby state, and controlling the first repeater to remain in the standby state in response to the device-side channel detection result indicating that the USB-device-side port is idle in the waiting transaction-finish mode.

18. The operating method according to claim 12, wherein the waiting transaction-finish mode comprises a host-to-device direction mode, a device-to-host direction mode, and a bidirectional standby mode, and the operating method further comprises:
detecting the signal of the USB-host-side port by the control circuit to obtain a host-side channel detection result;
detecting the signal of the USB-device-side port by the control circuit to obtain a device-side channel detection result;
changing the operation mode from the waiting transaction-start mode to the host-to-device direction mode by the control circuit in response to the host-side channel detection result indicating that a voltage level toggling occurs at a data channel of the USB-host-side port, wherein in the host-to-device direction mode, the first repeater operates in an active state to transmit at least one packet of the USB-host-side port to the USB-device-side port, and the second repeater operates in the standby state;
changing the operation mode from the host-to-device direction mode to the bidirectional standby mode by the control circuit in response to the host-side channel detection result indicating that the USB-host-side port is idle, wherein in the bidirectional standby mode, the first repeater and the second repeater both remain in the standby state;
changing the operation mode from the bidirectional standby mode to the host-to-device direction mode by the control circuit in response to the host-side channel detection result indicating that the voltage level toggling occurs at the data channel of the USB-host-side port;
changing the operation mode from the bidirectional standby mode to the device-to-host direction mode by the control circuit in response to the device-side channel detection result indicating that the voltage level toggling occurs at a data channel of the USB-device-side port, wherein in the device-to-host direction mode, the second repeater operates in the active state to transmit at least one packet of the USB-device-side port to the USB-host-side port, and the first repeater operates in the standby state;
changing the operation mode from the device-to-host direction mode to the bidirectional standby mode by the control circuit in response to the device-side channel detection result indicating that the USB-device-side port is idle; and
changing the operation mode from the bidirectional standby mode to the waiting transaction-start mode by the control circuit in response to the host-side-channel detection result and the device-side channel detection result indicating that both the USB-host-side port and the USB-device-side port are idle for a threshold time.

19. The operating method according to claim 12, further comprising:
controlling both the first repeater and the second repeater to operate in the power-off state in response to the operation mode entering a low-speed mode or a full-speed mode compliant with a USB specification; and
controlling the USB repeater device to enter the waiting transaction-start mode in response to the operation mode entering a high-speed mode compliant with the USB specification from the low-speed mode or the full-speed mode.
